(19) United States
(12) Patent Application Publication
(10) Pub. No.: US 2025/0118120 A1
(43) Pub. Date: Apr. 10, 2025

(54) PROXIMITY COMMUNICATION TRIGGERED WIRELESS POWERED LOCK

(71) Applicant: ASSA ABLOY AB, Stockholm (SE)

(72) Inventors: Adam Augustyn, Krzeszowice (PL); Krzysztof Grzegorz Fabjanski, Bielsko-Biala (PL); Andrzej Bohdan Kostyk, Wieliczka (PL)

(21) Appl. No.: 18/729,985

(22) PCT Filed: Jan. 19, 2022
(86) PCT No.: PCT/EP2022/051063

§ 371 Date: Jul. 18, 2024

(51) Int. Cl. G07C 9/00; H04B 5/77

(52) U.S. Cl. CPC G07C 9/00309; H04B 5/77; G07C 2009/00404; G07C 2009/00642

(57) ABSTRACT

Systems and methods may be used for providing wireless power from a mobile device to a digital lock. The mobile device may include a proximity communication antenna to receive an authentication request from the digital lock. The proximity communication antenna may facilitate the mobile device providing wireless power to the digital lock via a wireless power protocol. The proximity communication antenna may send an authorization to the digital lock to cause the digital lock to open.

### BACKGROUND

Locks and padlocks are used to secure access to physical spaces (e.g., rooms, floors, buildings, safes, cabinets, etc.). Digital locks and padlocks use electronic signaling to authenticate a user rather than, or in addition to, a physical key, number entry (e.g., rotary dial), or other non-electronic unlocking mechanism. Typically, digital locks and padlocks use a battery to power circuitry to authenticate an entry attempt and unlock.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for wirelessly unlocking a digital lock in accordance with some embodiments.

FIG. 2 illustrates example digital locks in accordance with some embodiments.

FIG. 3 illustrates a swim lane diagram for wirelessly unlocking a digital lock in accordance with some embodiments.

FIG. 4 illustrates a flowchart showing a technique for providing wireless power from a mobile device to a digital lock in accordance with some embodiments.

FIG. 5 illustrates generally an example of a block diagram of a machine upon which any one or more of the techniques discussed herein may perform in accordance with some embodiments.

### DETAILED DESCRIPTION

Digital locks and padlocks (generically referred to as locks, herein), as described above use circuitry to determine whether to unlock. Typically digital locks rely on a battery, which may run out of charge, to power the circuitry. In some examples, digital locks use mechanical energy harvesting. The energy harvesting mechanism makes the digital lock complicated (e.g., requires particular circuitry), and batteries have a limited lifetime.

The systems and techniques described herein provide a way to unlock a battery-less lock using remote wireless charging. Near field communications (NFC) or other proximity-based communications may be used to communicate with a digital lock. However, NFC does provide for power transfer of sufficient energy to perform mechanical actions on the digital lock. A wireless charging protocol, such as reverse Qi, may be used to provide power, and either NFC or the reverse Qi may be used for communication with the digital lock.

A technique may include sending, from a mobile device or other electronic device, an initial communication to a digital lock, and receiving an authentication request from the digital lock. The mobile device may provide wireless power to the digital lock, for example via a wireless power protocol (e.g., reverse Qi). When the digital lock has sufficient charge (e.g., in a capacitor of the digital lock), the digital lock may unlock, for example after receiving an authorization from the mobile device. The mobile device may store or access (e.g., download) authentication information corresponding to the authentication request. The mobile device or the digital lock may verify the authentication information includes authorization to open the digital lock.

By removing the need for a battery in the digital lock, the digital lock may be lighter, cheaper to manufacture (e.g., by not including the battery or circuitry), or more secure. The improved security may include more complex authentication (e.g., via the mobile device, such as two-factor authentication, etc.), removing reliance on circuitry of the digital lock to determine whether access is authorized, or the like.

A reverse Qi wireless power protocol is based on an open interface standard, Qi, which describes transfer of wireless power using inductance. The Qi standard includes remote charging (e.g., charging without direct contact between a charging device and a charged device), at close distances, such as up to four centimeters. Qi was developed by the Wireless Power Consortium, of New Jersey. The Qi standard describes wireless power transfer of up to 5W, 15W, or 60W, in some examples. The “reverse” term in reverse Qi refers to a mobile device (e.g., a cell phone) transmitting power using inductive coupling, rather than the mobile device receiving the power. However, in some examples, reverse Qi and Qi may be used interchangeably or describe identical techniques.

In some examples, receiving and transmitting circuitry for wireless power transfer may be identical (e.g., a transceiver of wireless power). In other examples, receiving and transmitting circuitry may differ, and in these examples, a device (e.g., the mobile device) may include both receiving and transmitting circuitry. The mobile device may include a battery, which may be used to draw power to transmit wirelessly. A digital lock may include a capacitor (e.g., a super capacitor) to store wirelessly received power. In an example, a digital lock may include a battery for storing wirelessly received power.

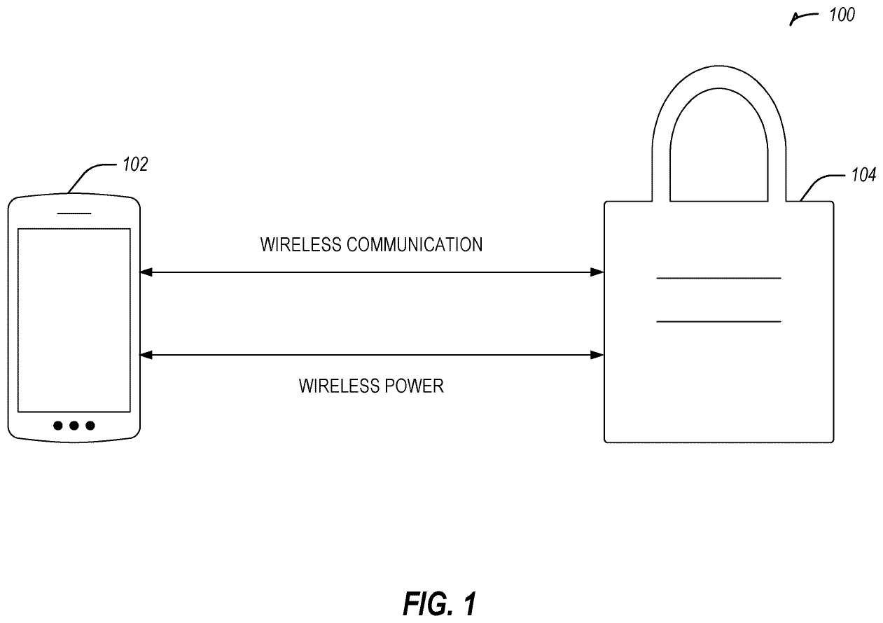

FIG. 1 illustrates a diagram of a system 100 for wirelessly unlocking a digital lock in accordance with some embodiments. The system includes a mobile device 102 (e.g., a cell phone, a tablet, a computer, a wearable device, etc.) and a digital lock 104 (e.g., a lock, a padlock, a dead bolt, a cabinet lock, a cam lock, a safe lock, or any other type of physical lock).

The mobile device 102 may communicate via a wireless communication (e.g., via a protocol such as NFC) with the digital lock 104. The mobile device 102 may provide wireless power (e.g., via a protocol such as Qi), to the digital lock 104. In some examples, the wireless power may be provided automatically when the mobile device 102 is within power providing range of the digital lock 104. In this example, the power may be automatically provided based on a prior authentication, a previous communication (e.g., a previous session), a stored signal at the digital lock 104 or the mobile device 102, an app or background process of the mobile device 102 or the like.

The mobile device 102 may wirelessly charge (e.g., via a reverse Qi process) the digital lock 104 over a period of time (e.g., a few seconds, a few minutes, etc.). The charge may be stored in a capacitor of the digital lock 104 (e.g., a super capacitor). The stored charge may be used to unlock the digital lock 104. For example, a switch, lever, or other lock engaging mechanism may be released using the power stored in the capacitor. Once the locking mechanism is disengaged from locking the digital lock 104, the capacitor may be discharged or may be allowed to retain charge (which may be discharged over time naturally). In an example, the digital lock 104 or the mobile device 102 may include circuitry to determine when sufficient charge has been transferred to the digital lock 104, and stop the wireless charging after the sufficient charge is received at the digital lock 104.

The digital lock 104 or the mobile device 102 may verify that the mobile device 102 is compatible with the digital lock 104 to transfer wireless power, in some examples. This verification may occur with authentication or authorization to open the digital lock 104, or may be part of a separate communication.

The digital lock 104 may include an NFC interface (e.g., a passive element such as an NFC tag, RFID, or other secure element). The NFC interface of the digital lock 104 may be discoverable by the mobile device 102. For example, when NFC or other wireless communication is enabled at the mobile device 102, the mobile device 102 may send discovery signals and receive a communication from the digital lock 104, when in range. After discovery, the mobile device 104 may initiate a user interface to display (e.g., via an app that may be started or that is running on the mobile device 104). The user interface may be used to collect data required to open the digital lock 104 (e.g., lock identity, authenticated nonce, etc.).

In an example, after positive validation, the NFC interface may be deactivated. A wireless power interface may be activated to transfer energy to finish an authorization transaction or open the digital lock 104. Authorization may be finished using a data transfer mechanism built-in into the wireless charging (e.g., via a modification of Qi authentication) or may be completed using NFC. In the NFC example, the wireless charging interface may be deactivated when sufficient energy has been transferred to the digital lock 104. In this example, the NFC interface may be activated again (or was not deactivated previously) to finish the transaction and open the digital lock 104.

In an example where the digital lock 104 does not have a battery, the digital lock 104 avoids needing a battery. By avoiding using a battery, the digital lock 104 does not have a lifetime limit (e.g., with a rechargeable battery) or does not need to be removed from use periodically (e.g., to recharge a rechargeable battery or to replace a battery). In an example where the digital lock 104 does not have a battery, the digital lock 104 avoids a potential security issue that may arise with errant behavior of a digital lock with a run-down or faulty battery (e.g., accidentally releasing the lock).

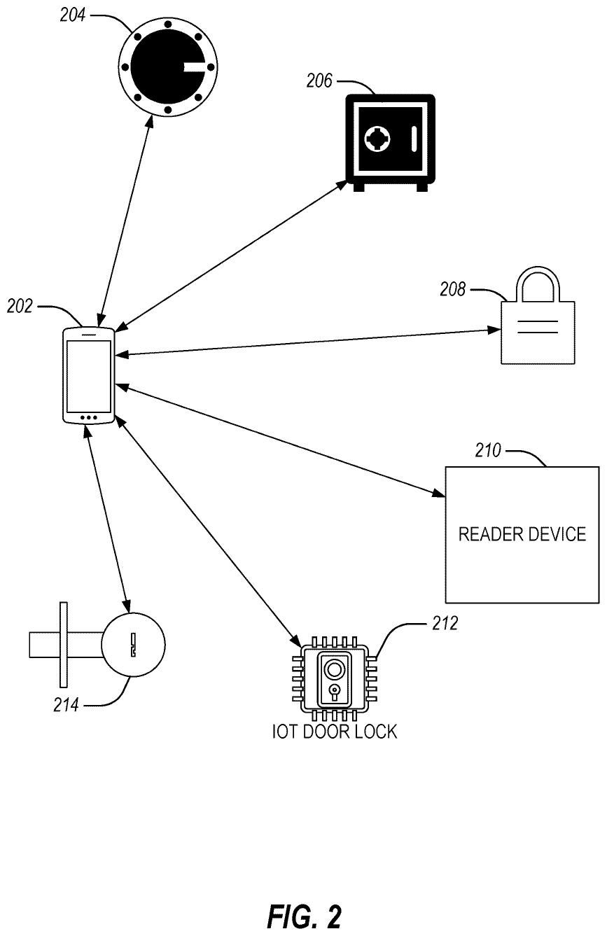

FIG. 2 illustrates example digital locks in accordance with some embodiments. The example digital locks include a vault lock 204, a safe lock 206, a padlock 208, a door lock 210 (e.g., a reader device or other door lock controller), an internet of things door lock 212, a deadbolt 214, etc. A mobile device 202 (e.g., the mobile device 102 of FIG. 1) may be used to communicate and wirelessly power one or more of the example locks of FIG. 2. In some examples, although a lock may be located in a place that has access to grid power (e.g., the vault lock 204, the safe lock 206, the door lock 210, etc.), the lock itself may be separated from the power grid for security reasons, and may be used with the systems and techniques described herein for receiving wireless power from the mobile device 202. In some examples, a lock may receive wireless power from a non-mobile device. For example, the vault lock 204 or the door lock 210 may receive wireless power from a device connected to grid power located in proximity to the lock.

The lack of direct wired connection may provide additional security (e.g., against power surge attacks). The ability to receive wireless power may be used for safety purposes (e.g., should a person become trapped inside a vault during a power outage). The wireless power transfer may provide improved convenience, for example for users with the deadbolt 214, who may prefer to use automatic opening via the mobile device 202 rather than using a key or entering a code.

In an example, access to a lock may be given to a particular mobile device (e.g., mobile device 202). A user may give access to open the lock to a mobile device. For example, a real estate agent may give access to a potential buyer's mobile device to open a lock at a home. In another example, a rideshare bike may have a lock that is openable by a mobile device granted access by a rideshare operator. A safety deposit box may be opened by a mobile device granted access, according to an example.

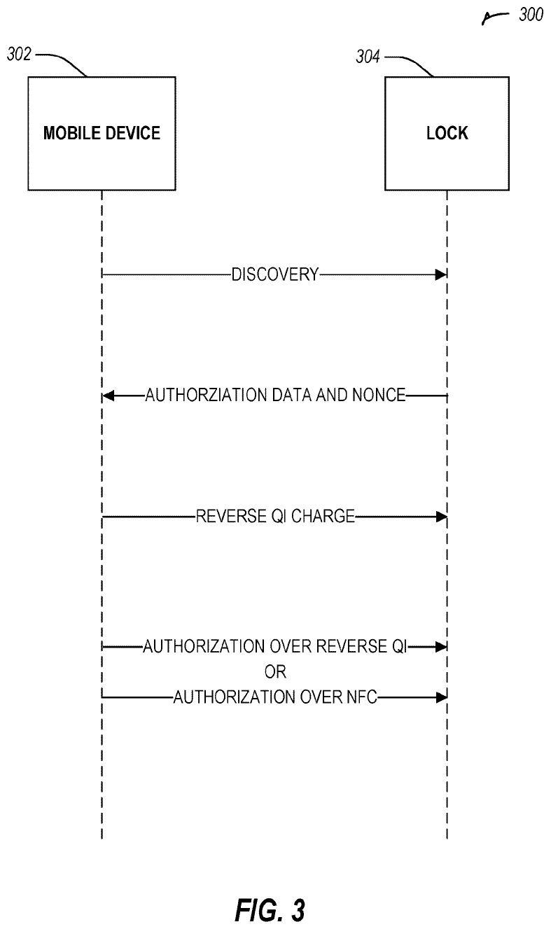

FIG. 3 illustrates a swim lane diagram 300 for wirelessly unlocking a digital lock in accordance with some embodiments. The diagram 300 illustrates example interactions between a mobile device 302 and a lock 304. The interactions of diagram 300 include example ordered communication and wireless power transfer interactions. Though shown in an ordered manner in the diagram 300, other orders, combinations, or interactions may be used or interspersed without deviating from the disclosure herein.

The mobile device 302 may send a discover communication to the lock 304 to initiate an interaction. The discovery may occur when the mobile device 302 is placed in proximity to the lock 304, when the mobile device 302 is instructed to look for a nearby device (e.g., via NFC), or the like. After the initial discovery message, the lock 304 may be read (or may send) to provide an authorization data and nonce message to the mobile device 302. This interaction may occur via NFC. The authorization data may include verifying that the mobile device 302 is authorized to open the lock 304 (e.g., based on data from the discovery message, in some examples). In some examples, the authorization data and nonce include information corresponding to the lock 304, and the mobile device 302 may separately authenticate a user attempting to open the lock 304. The discovery operation may include determining whether the mobile device 302 is capable of providing wireless power to the lock 304.

After initial correspondence via NFC or another proximate wireless communication protocol, the mobile device 302 may provide charge to the lock 304 (e.g., via a revers Qi charge). The power may be used to complete a transaction or the power may be used to open the lock 304. In an example, after providing the wireless power to the lock 304, the mobile device 302 may communicate via NFC to provide authorization or credentials to the lock 304 to open. In another example, the mobile device 302 may communicate over reverse QI to provide authorization or credentials to the lock 304 to open. When the reverse Qi is used to communicate authorization, the NFC (e.g., an NFC antenna at the mobile device 302 or the lock 304) may be deactivated. When the NFC is used to provide the authorization, the NFC may be deactivated and then reactivated, or maintained throughout.

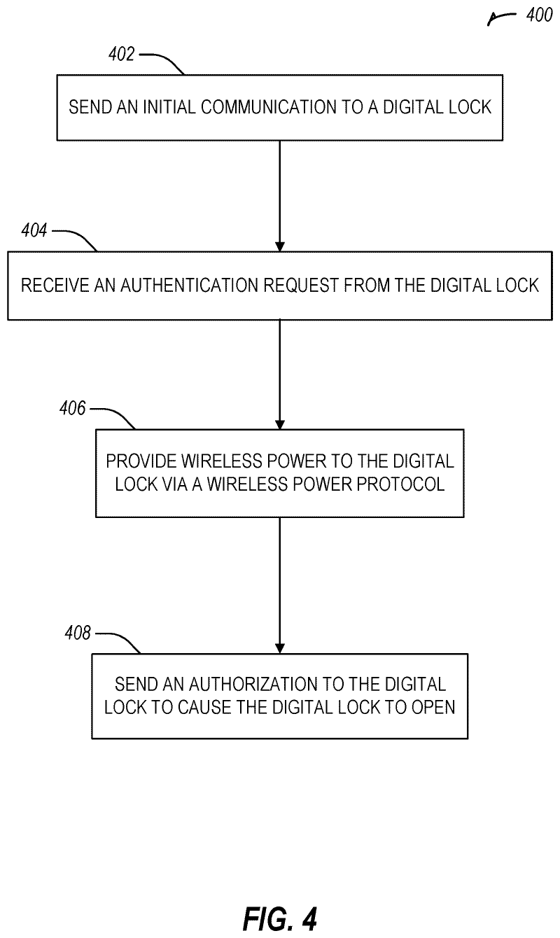

FIG. 4 illustrates a flowchart showing a technique 400 for providing wireless power from a mobile device to a digital lock in accordance with some embodiments. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 1.

The technique 400 includes an operation 402 to send (e.g., using a proximity communication antenna) an initial communication to a digital lock. In an example, the proximity communication antenna is a near field communication (NFC) antenna.

The technique 400 includes an operation 404 to receive (e.g., via the proximity communication antenna) an authentication request from the digital lock.

The technique 400 includes an operation 406 to provide (e.g., from a battery of the mobile device) wireless power to the digital lock via a wireless power protocol. The wireless power protocol may include a reverse Qi protocol. Operation 406 may include providing the wireless power to charge a capacitor of the digital lock. In an example, the digital lock does not include a battery (e.g., instead includes a capacitor that may be charged wirelessly).

The technique 400 includes an operation 408 to send an authorization to the digital lock to cause the digital lock to open. In an example, operation 408 includes sending the authorization using a reverse Qi protocol or sending the authorization includes sending the authorization using a near field communication (NFC) antenna of the mobile device. Before operation 408, the technique 400 may include determining, for example using a processor of the mobile device, whether a user of the mobile device is authorized to open the digital lock based on credentials stored at the mobile device. Operation 408 may occur in response to determining that the user is authorized to open the digital lock.

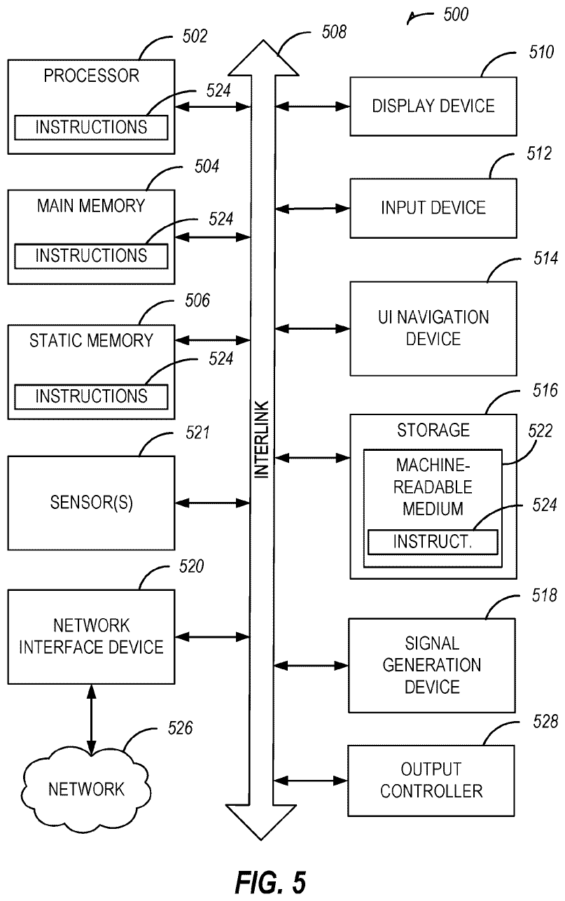

FIG. 5 illustrates generally an example of a block diagram of a machine 500 upon which any one or more of the techniques (e.g., methodologies) discussed herein may perform in accordance with some embodiments, such as computing device 102 or a device operating in the cloud 112. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Example 1 is a method performed by a mobile device, the method comprising: sending, using a proximity communication antenna, an initial communication to a digital lock; receiving, via the proximity communication antenna, an authentication request from the digital lock; providing, from a battery of the mobile device, wireless power to the digital lock via a wireless power protocol; and sending an authorization to the digital lock to cause the digital lock to open.

In Example 2, the subject matter of Example 1 includes, wherein the proximity communication antenna is a near field communication (NFC) antenna.

In Example 3, the subject matter of Examples 1-2 includes, wherein the wireless power protocol is a reverse Qi protocol.

In Example 4, the subject matter of Examples 1-3 includes, wherein sending the authorization includes sending the authorization using a reverse Qi protocol.

In Example 5, the subject matter of Examples 1-4 includes, wherein sending the authorization includes sending the authorization using a near field communication (NFC) antenna of the mobile device.

In Example 6, the subject matter of Examples 1-5 includes, wherein providing the wireless power includes providing the wireless power to charge a capacitor of the digital lock.

In Example 7, the subject matter of Examples 1-6 includes, wherein the digital lock does not include a battery.

In Example 8, the subject matter of Examples 1-7 includes, wherein before sending the authorization to the digital lock, determining, using a processor of the mobile device, whether a user of the mobile device is authorized to open the digital lock based on credentials stored at the mobile device.

Example 9 is a mobile device comprising: processing circuitry to initiate a communication session with a digital lock; and a proximity communication antenna to: send, in response to the initiation of the communication session by the processing circuitry, an initial communication to a digital lock; receive an authentication request from the digital lock; provide, using a battery of the mobile device, wireless power to the digital lock via a wireless power protocol; and send an authorization to the digital lock to cause the digital lock to open.

In Example 10, the subject matter of Example 9 includes, wherein the proximity communication antenna is a near field communication (NFC) antenna.

In Example 11, the subject matter of Example 10 includes, wherein to send the authorization includes to send the authorization using the NFC antenna.

In Example 12, the subject matter of Examples 9-11 includes, wherein the wireless power protocol is a reverse Qi protocol.

In Example 13, the subject matter of Examples 9-12 includes, wherein to send the authorization includes to send the authorization using a reverse Qi protocol.

In Example 14, the subject matter of Examples 9-13 includes, wherein to provide the wireless power includes to provide the wireless power to charge a capacitor of the digital lock.

In Example 15, the subject matter of Examples 1-14 includes, wherein the digital lock does not include a battery.

In Example 16, the subject matter of Examples 1-15 includes, wherein before sending the authorization to the digital lock, the processing circuitry is further to determine whether a user of the mobile device is authorized to open the digital lock based on credentials stored at the mobile device.

Example 17 is a system comprising: a digital lock; and a mobile device including a proximity communication antenna to: send an initial communication to the digital lock; receive an authentication request from the digital lock; provide, using a battery of the mobile device, wireless power to the digital lock via a wireless power protocol; and send an authorization to the digital lock to cause the digital lock to open.

In Example 18, the subject matter of Example 17 includes, wherein the digital lock does not include a battery.

In Example 19, the subject matter of Examples 17-18 includes, wherein the proximity communication antenna is a near field communication (NFC) antenna.

In Example 20, the subject matter of Examples 17-19 includes, wherein the wireless power protocol is a reverse Qi protocol.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method performed by a mobile device, the method comprising:
sending, using a proximity communication antenna, an initial communication to a digital lock;
receiving, via the proximity communication antenna, an authentication request from the digital lock;
providing, from a battery of the mobile device, wireless power to the digital lock via a wireless power protocol; and
sending an authorization to the digital lock to cause the digital lock to open.

2. The method of claim 1, wherein the proximity communication antenna is a near field communication (NFC) antenna.

3. The method of claim 1, wherein the wireless power protocol is a reverse Qi protocol.

4. The method of claim 1, wherein sending the authorization includes sending the authorization using a reverse Qi protocol.

5. The method of claim 1, wherein sending the authorization includes sending the authorization using a near field communication (NFC) antenna of the mobile device.

6. The method of claim 1, wherein providing the wireless power includes providing the wireless power to charge a capacitor of the digital lock.

7. The method of claim 1, wherein the digital lock does not include a battery.

8. The method of claim 1, wherein before sending the authorization to the digital lock, determining, using a processor of the mobile device, whether a user of the mobile device is authorized to open the digital lock based on credentials stored at the mobile device.

9. A mobile device comprising:
processing circuitry to initiate a communication session with a digital lock; and
a proximity communication antenna to:
send, in response to the initiation of the communication session by the processing circuitry, an initial communication to a digital lock;
receive an authentication request from the digital lock;
provide, using a battery of the mobile device, wireless power to the digital lock via a wireless power protocol; and
send an authorization to the digital lock to cause the digital lock to open.

10. The mobile device of claim 9, wherein the proximity communication antenna is a near field communication (NFC) antenna.

11. The mobile device of claim 10, wherein to send the authorization includes to send the authorization using the NFC antenna.

12. The mobile device of claim 9, wherein the wireless power protocol is a reverse Qi protocol.

13. The mobile device of claim 9, wherein to send the authorization includes to send the authorization using a reverse Qi protocol.

14. The mobile device of claim 9, wherein to provide the wireless power includes to provide the wireless power to charge a capacitor of the digital lock.

15. The mobile device of claim 9, wherein the digital lock does not include a battery.

16. The mobile device of claim 9, wherein before sending the authorization to the digital lock, the processing circuitry is further to determine whether a user of the mobile device is authorized to open the digital lock based on credentials stored at the mobile device.

17. A system comprising:
a digital lock; and
a mobile device including a proximity communication antenna to:
send an initial communication to the digital lock;
receive an authentication request from the digital lock;
provide, using a battery of the mobile device, wireless power to the digital lock via a wireless power protocol; and
send an authorization to the digital lock to cause the digital lock to open.

18. The system of claim 17, wherein the digital lock does not include a battery.

19. The system of claim 17, wherein the proximity communication antenna is a near field communication (NFC) antenna.

20. The system of claim 17, wherein the wireless power protocol is a reverse Qi protocol.
